(19) United States
(12) Patent Application Publication
(10) Pub. No.: US 2009/0312461 A1
(43) Pub. Date: Dec. 17, 2009

(54) Stabilized fluoroelastomer latex compositions

(76) Inventor: Peter A. Fox, Wilmington, DE (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(21) Appl. No.: 12/157,567

(22) Filed: Jun. 11, 2008

(51) Int. Cl. C08L 1/02; C08L 77/00; C08L 27/16; C08L 27/18

(52) U.S. Cl. 524/13; 524/514; 524/520

(57) ABSTRACT

A fluoroelastomer latex composition stabilized against settling with from 1 wt % up to 50 wt % of a natural or synthetic pulp, comprising fibers having an average length of from 0.1 mm to 13 mm, uniformly dispersed therein.

### BACKGROUND OF THE INVENTION

The present invention relates to fluoroelastomer latex compositions having improved stability against settling, and, more particularly, to a method for stabilizing fluoroelastomer latex compositions against settling using an effective amount of a natural or synthetic pulp.

The use of aramid fibers, and particularly aramid pulp, as a reinforcing agent in elastomer compositions is known. U.S. Pat. Nos. 5,480,941 and 5,391,623, for example, describe dispersing aramid pulp into solutions of several different elastomers and then evaporating the solvent to yield thin flake-like particles suitable for compounding with other elastomers as a masterbatch.

U.S. Pat. No. 6,344,512 B1 describes latex elastomer based compounds, including fluoroelastomers, comprised of 5-35% aramid fiber, barium sulfate magnesium oxide, carbon black filler and metal oxide that are useful in making oil seals.

European Patent Publication 0 272 459 B1 describes a particulate elastomeric composition which is suitable for use as a masterbatch material consisting of aramid pulp, reinforcing filler, and a liquid elastomer. The masterbatch material is made by thoroughly mixing the aramid pulp and the reinforcing filler and then combining the pulp and filler with the liquid elastomer. The aramid pulp has lengths from 0.1 to 8 mm, and the liquid elastomer is polybutadiene or a copolymer of butadiene and acrylonitrile.

U.S. Pat. No. 3,962,169 describes fluoroelastomer latex compositions that have excellent shelf life as a result of creaming the fluoroelastomer latex with from 0.07-3 grams of a creaming agent, such as ammonium alginate or sodium alginate, per 100 grams of fluoroelastomer present in the composition. U.S. Pat. No. 6,169,139 B1 teaches that solids-rich fluoroelastomer latex compositions may be subjected to multiple creaming steps, and that creamed lattices exhibit improved storage stability, i.e., if stirred on a regular basis, non-redispersible sludges do not develop within 6 months.

The present invention can stabilize fluoroelastomer latex compositions and thereby overcome the problem of settling so that the compositions can be transported and held for further processing at locations remote from their initial preparation.

### SUMMARY OF THE INVENTION

The present invention according to one embodiment is a process for producing a fluoroelastomer latex composition having improved stability against settling. Fresh fluoroelastomer latex is typically prepared directly using a batch, semi-batch or continuous process, by polymerizing fluorinated monomers in an aqueous emulsion or suspension, which comprises:
(a) forming an aqueous emulsion of monomers capable of being copolymerized,
(b) polymerizing the emulsion to form a fluoroelastomer emulsion composition,
(c) optionally adjusting the pH of the emulsion, and
(d) optionally concentrating the fluoroelastomer emulsion composition to form a solids-rich fluoroelastomer latex composition.
   The invention comprises uniformly distributing within the fresh fluoroelastomer latex composition from 1 wt % up to 50 wt %, with respect to the amount of fluoroelastomer in the composition, of a heterogeneous dispersing agent selected from natural or synthetic pulp. The presence of a natural or synthetic pulp unexpectedly stabilizies the fluoroelastomer latex composition to the extent that it can be transported and held for further processing at locations remote from is initial synthesis without the fluoroelastomer portion of the composition settling out and without the need for regular stirring. In a preferred embodiment of the invention, the natural or synthetic pulp or micropulp is aramid pulp comprising staple fibers having an average length of from about 0.1 mm to 4.0 mm, although fibers as long as 13 mm can produce satisfactory results.

Among the monomers capable of being copolymerized to form an aqueous emulsion in practicing the above-defined process are vinylidene fluoride and/or tetrafluoroethylene and at least one other monomer. The at least one other monomer can be a fluorinated monomer selected from the group consisting of hexafluoropropylene, chlorotrifluoroethylene, 2-hydropentafluoropropene, 1-hydropentafluoropropene, dichlorodifluoroethylene, tetrafluoroethylene, and perfluorinated alkyl vinyl ethers selected from the group consisting of trifluoromethyl trifluorovinyl ether, heptafluoropropyl trifluorovinyl ether, and 3,3,3-trifluoropropene, or it can be non-fluorinated monomer selected from ethylene and propylene.

According to another embodiment, the present invention is a method for stabilizing a fresh fluoroelastomer latex composition against settling which comprises uniformly distributing within the fluoroelastomer latex composition from 1 wt % up to 50 wt % of a natural or synthetic pulp, based on the concentration of fluoroelastomer in the composition, wherein the pulp comprises fibers having an average length of from about 0.1 mm to about 13.0 mm. As noted above, a “fresh” fluoroelastomer latex composition as contemplated according to this invention is a latex composition as it exists post-reactor being derived from an aqueous emulsion of fluorinated monomers capable of being copolymerized by direct polymerization.

### DETAILED DESCRIPTION OF THE INVENTION

According to the present invention, fresh fluoroelastomer lattices are prepared via a process which comprises polymerization, optional pH adjustment of the thus-prepared fluoroelastomer emulsion, and optional concentration of the emulsion to form a solids-rich latex composition. At any time after polymerization, i.e., post-reactor, the invention comprises uniformly distributing from 1 wt % up to 50 wt % of a heterogeneous dispersing agent selected from natural or synthetic pulp within the fluoroelastomer latex composition. The presence of such a dispersing agent within the latex composition protects the fluoroelastomer portion of the composition against settling. The natural or synthetic pulp comprises fibers selected from having an average length of from 0.1 mm up to 13 mm.

In the first step of the polymerization process for preparing a fresh fluoroelastomer latex, an aqueous emulsion of at least two monomers is formed. The first monomer is selected from the group consisting of vinylidene fluoride and tetrafluoroethylene. At least one other fluorinated monomer is also present in the emulsion. The emulsion is generally formed by introduction of gaseous monomers and water into a reaction vessel.

Examples of common fluorinated monomers which can be copolymerized with vinylidene fluoride to form fluoroelastomers and which are useful in the practice of the invention include hexafluoropropylene, chlorotrifluoroethylene, 2-hydropentafluoropropene, 1-hydropentafluoropropene, dichlorodifluoroethylene, tetrafluoroethylene and perfluorinated alkyl vinyl ethers, for example trifluoromethyl trifluorovinyl ether, pentafluoroethyl trifluorovinyl ether, heptafluoropropyl trifluorovinyl ether, and and 3,3,3-trifluoropropene. It is preferable that the fluorinated monomer capable of copolymerization with vinylidene fluoride contain at least as many fluorine atoms as carbon atoms. Elastomeric copolymers of vinylidene fluoride and hexafluoropropylene are described in U.S. Pat. No. 3,051,677. Elastomeric copolymers of vinylidene fluoride and pentafluoropropenes are described in U.S. Pat. No. 3,331,823.

Examples of fluorinated monomers which can be copolymerized with tetrafluoroethylene to form fluoroelastomers include perfluoro(alkyl vinyl) ethers, vinylidene fluoride and 2-hydropentafluoropropene. Elastomeric copolymers of tetrafluoroethylene, trifluoromethyl trifluorovinyl ether, chlorotrifluoroethylene, and 2-hydropentafluoropropene are described in U.S. Pat. No. 5,719,245.

In addition to fluorinated monomers, copolymerizable non-fluorinated comonomers may also be present. The fluoroelastomer emulsion produced during polymerization will then be an emulsion of a higher order elastomeric copolymer, such as a terpolymer or tetrapolymer. Examples of suitable copolymerizable non-fluorinated comonomers include ethylene and propylene.

An example of a fluoroelastomer terpolymer containing only fluorinated comonomers that may be prepared as an emulsion according to the process of the present invention is a copolymer of vinylidene fluoride, hexafluoropropylene, and tetrafluoroethylene. Examples of fluoroelastomer terpolymers containing non-fluorinated monomers that may be prepared as emulsions according to the invention include copolymers of vinylidene fluoride, tetrafluoroethylene, and propylene and copolymers of ethylene, tetrafluoroethylene and trifluoromethyl trifluorovinyl ether.

The fluoroelastomer copolymer latex compositions to which this invention applies may also include any cure site monomer commonly used in fluoroelastomers, including, but not limited to, a brominated or iodinated olefin. Examples of such olefins include 4-bromotetrafluorobutene-1, bromotrifluoroethylene, 4-iodotetrafluorobutene-1, and iodotrifluoroethylene.

The present invention is also applicable in stabilizing perfluoroelastomer latices. That is, the polymeric component of the latex may be a copolymer of tetrafluoroethylene, at least one other perfluorinated compound and, generally, a small amount of a perfluorinated or non-perfluorinated cure site monomer.

Examples of perfluorinated comonomers which may be polymerized with tetrafluoroethylene to form perfluoroelastomers include perfluoro(alkyl vinyl) ethers, such as, for example, trifluoromethyl trifluorovinyl ether and heptafluoropropyl trifluorovinyl ether. Suitable perfluorinated vinyl ethers are those of the formula

CF₂═CFO(R_{f}′O)ₙ(R_{f}″O)ₘR_{f} (I)

where R_{f}′ and R_{f}″ are different linear or branched perfluoroalkylene groups of 2-6 carbon atoms, m and n are independently 0-10, and R_{f} is a perfluoroalkyl group of 1-6 carbon atoms.

Other cure site monomers include olefins represented by the formula R₁CH.dbd.CR₂R₃, wherein R₁ and R₂ are independently selected from hydrogen and fluorine, and R₃ is independently selected from hydrogen, fluorine, alkyl, and perfluoroalkyl. The perfluoroalkyl group may contain up to about 12 carbon atoms. However, perfluoroalkyl groups of up to 4 carbon atoms are typical for articles used in commercial applications, and the cure site monomer usually has no more than three hydrogen atoms. Examples of such olefins include ethylene, vinylidene fluoride, vinyl fluoride, trifluoroethylene, 1-hydropentafluoropropene, and 2-hydropentafluoropropene, as well as brominated olefins such as 4-bromo-tetrafluorobutene-1 and bromotrifluoroethylene and iodinated olefins, such as 4-iodotetrafluorobutene-1 and iodotrifluoroethylene.

Fluoroelastomer latex compositions to which this invention is applicable can be prepared by free radical polymerization in an emulsion system in the presence of a free radical initiator. The most common free-radical initiators are 1) water soluble ammonium or potassium persulfate or 2) the redox system potassium persulfate and sodium sulfite. The initiator catalyzes the polymerization reaction and is generally present in amounts sufficient to give a radical flux of from 5 to 100 mmol/kg polymer. It is possible to minimize ionic end group concentrations by conducting the polymerization in the presence of low levels of chain transfer agents.

Hydrogen-based alcohols, esters and halogens as well as various iodinated compounds, including diiodomethane, and fluoroalkyl iodides have been used with good results. Chain transfer agents which are not perfluorinated can be used in the polymerization reaction to introduce desirable fragments into the polymer chain for curing purposes, and are considered cure site moieties. Such agents include diiodo compounds that result in bound iodine, commonly at the end of the polymer chains. Preparative techniques for the fluoroelastomers and perfluoroelastomer latex compositions are described in general in Logothetis, Prog. Polymn. Sci, Vol. 14, 251-296 (1989) and in U.S. Pat. Nos. 4,281,092; 5,789,489; and 5,789,509.

The aqueous emulsion formed during the first step of the polymerization process is generally prepared in a continuous stirred tank reactor, although batch or semi-batch reactors may also be used. If the aqueous emulsion is prepared in a continuous process, aqueous solutions containing polymerization catalysts, surfactants, optional reducing agents, chain transfer agents, and buffers are added to the continuously stirred reactor. Simultaneously, monomers are fed to the reactor. Polymerization occurs, thereby resulting in production of a fresh fluoroelastomer latex composition. It has been found that surfactants aid the polymerization process. In addition, the presence of surfactants may foster the production of a small particle size emulsion. A small particle size latex is desirable because small particles have a reduced tendency to settle, but settling, which is undesirable and irreversible, is inevitable irrespective of particle size. The emulsion resulting from a continuous polymerization will typically have a solids content of around 20 percent by weight. It is possible to produce an emulsion having a somewhat higher solids level through use of a semi-batch or batch process. Higher solids levels are sometimes preferred based on the intended application, since the rate at which a latex dries, after it has been applied to a substrate as a film, for example, is dependent on the solids content of the latex. That is, the less water that is present, the faster the latex will dry to form a continuous film.

Polymerization temperatures typically range from 40°-130° C., at pressures of 2 to 9 MPa and residence times of 10 to 240 minutes. A residence time of 20 to 60 minutes is typically followed for vinylidene fluoride copolymers. After polymerization, unreacted monomer may be removed from the reactor effluent by vaporization at reduced pressure, and further surfactant may be added.

Following preparation of the fluoroelastomer latex composition, its pH may be adjusted by addition of base. The base may be added before, in conjunction with, or following addition of the surfactant. That is, the order of addition of base and the optional additional surfactant is not critical. The amount of base added will be a quantity sufficient to adjust the pH of the fluoroelastomer latex composition to a value in the range of from 5 to 8. Inorganic or organic bases may be used, but typically sodium hydroxide, lithium hydroxide, potassium hydroxide, and ammonium hydroxide are utilized because of their availability and lower cost. At this stage the finished latex composition typically has a solids content of about 20-40 wt %.

The present invention is carried out by incorporating into the fresh fluoroelastomer latex composition, i.e., as it exists post-reactor following polymerization, from 1 wt % up to 50 wt % of a natural or synthetic pulp. Among the various pulps that can produce satisfactory results when used according to the invention are wood pulp, aramid pulp, acrylic pulp, viscose (rayon) pulp, and polyolefin pulp.

In a preferred embodiment, the pulp is an aramid pulp that comprises staple fibers having an average length of from 0.1 mm to 4.0 mm. By “aramid” is meant a polyamide wherein at least 85% of the amide (—CO—NH—) linkages are attached directly to two aromatic rings.

Incorporation into the latex composition can be by any convenient mixing means so that the pulp is uniformly distributed throughout the latex composition. The term “aramid pulp” is used herein to mean a synthetic pulp, for example, as made by mechanical shattering of fibers derived from high strength, high modulus aromatic polyamide fibers, such as those described in U.S. Pat. Nos. 3,869,429 and 3,869,430. Aramid fibers are shattered both transversely and longitudinally to provide fibers having a length which depends on the degree of refinement. Attached to these fibers are fine fibrils which have a diameter as small as 0.1 micrometer as compared with a diameter of about 12 micrometers for the main (trunk) part of the fiber. Aramid pulp particles have the appearance of hairy fibers.

A process for producing a compacted, redispersible aramid pulp, wherein the aramid pulp is opened using forces of a turbulent air grinding mill, is described in U.S. Pat. Nos. 5,171,402 and 5,084,136.

Particularly preferred because of its availability and cost is aramid pulp derived from poly(p-phenylene terephthalamide) fibers.

1. In a process for producing a fluoroelastomer latex composition which comprises:
(a) forming an aqueous emulsion of monomers capable of being copolymerized,
(b) polymerizing the emulsion to form a fluoroelastomer emulsion composition,
(c) optionally adjusting the pH of the emulsion, and
(d) optionally concentrating the fluoroelastomer emulsion composition to form a solids-rich fluoroelastomer latex composition, the improvement comprising uniformly distributing within said fluoroelastomer latex composition from 1 wt % up to 50 wt % of a heterogeneous dispersing agent selected from natural or synthetic pulp whereby the fluoroelastomer portion of the latex composition is stabilized against settling.

2. The process of claim 1 wherein said natural or synthetic pulp is selected from the group consisting of wood pulp, aramid pulp, acrylic pulp, viscose (rayon) pulp, and polyolefin pulp comprising fibers having an average length of from 0.1 mm to 13 mm.

3. The process of claim 2 wherein the pulp is aramid pulp comprising fibers having an average length of from 0.1 mm to 4.0 mm.

4. The process of claim 3 wherein said monomers capable of being copolymerized are selected from vinylidene fluoride or tetrafluoroethylene and at least one other monomer.

5. The process of claim 4 in which said at least one other monomer is a fluorinated monomer selected from the group consisting of hexafluoropropylene, chlorotrifluoroethylene, 2-hydropentafluoropropene, 1-hydropentafluoropropene, dichlorodifluoroethylene, tetrafluoroethylene, and perfluorinated alkyl vinyl ethers selected from the group consisting of trifluoromethyl trifluorovinyl ether, heptafluoropropyl trifluorovinyl ether, and 3,3,3-trifluoropropene.

6. The process of claim 4 wherein said at least one other monomer is a non-fluorinated monomer selected from ethylene and propylene.

7. The process of claim 1 wherein said fluoroelastomer is a terpolymer derived from vinylidene fluoride, hexafluoropropylene and tetrafluoroethylene.

8. A method for stabilizing a fluoroelastomer latex composition against settling wherein the fluoroelastomer latex composition is derived from an aqueous emulsion of monomers capable of being copolymerized, said method comprising uniformly distributing within said fluoroelastomer latex composition from 1 wt % up to 50 wt % of a heterogeneous dispersing agent selected from natural or synthetic pulp.

9. The method of claim 8 wherein said natural or synthetic pulp is selected from the group consisting of wood pulp, aramid pulp, acrylic pulp, viscose (rayon) pulp, and polyolefin pulp comprising fibers having an average length of from 0.1 mm to 13 mm.

10. The method of claim 9 wherein the pulp is aramid pulp comprising fibers having an average length of from 0.1 mm to 4.0 mm and said monomers capable of being copolymerized are selected from vinylidene fluoride or tetrafluoroethylene and at least one other monomer.

11. The method of claim 10 in which said at least one other monomer is a fluorinated monomer selected from the group consisting of hexafluoropropylene, chlorotrifluoroethylene, 2-hydropentafluoropropene, 1-hydropentafluoropropene, dichlorodifluoroethylene, tetrafluoroethylene, and perfluorinated alkyl vinyl ethers selected from the group consisting of trifluoromethyl trifluorovinyl ether, heptafluoropropyl trifluorovinyl ether, and 3,3,3-trifluoropropene.

12. The method of claim 10 wherein said at least one other monomer is a non-fluorinated monomer selected from ethylene and propylene.

13. The method of claim 8 wherein said fluoroelastomer is a terpolymer derived from vinylidene fluoride, hexafluoropropylene and tetrafluoroethylene.

14. A fluoroelastomer latex composition stabilized against settling which results from:
(a) forming an aqueous emulsion of monomers capable of being copolymerized, and
(b) polymerizing the emulsion to form a fluoroelastomer emulsion composition, and
(c) uniformly dispersing in said emulsion composition from 1 wt % up to 50 wt % of aramid pulp comprising fibers having an average length of from 0.1 mm to 4 mm.
